(19) United States
(12) Patent Application Publication
(10) Pub. No.: US 2018/0253902 A1
(43) Pub. Date: Sep. 6, 2018

(54) METHOD EXECUTED ON COMPUTER FOR PROVIDING OBJECT IN VIRTUAL SPACE, PROGRAM FOR EXECUTING THE METHOD ON THE COMPUTER, AND COMPUTER APPARATUS

(71) Applicant: COLOPL, Inc., Tokyo (JP)

(72) Inventor: Atsushi INOMATA, Kanagawa (JP)

(21) Appl. No.: 15/846,651

(22) Filed: Dec. 19, 2017

(30) Foreign Application Priority Data
Dec. 20, 2016 (JP) 2016-246965

(51) Int. Cl. G06T 19/00; G06T 7/70; G06F 3/01; H04L 29/06; H04N 13/383

(52) U.S. Cl. CPC G06T 19/006; G06T 7/70; G06F 3/013; H04N 13/344; H04L 67/38; H04N 13/383; G06F 3/014

(57) ABSTRACT

A method includes defining a virtual space including a light source, a first object, and a second object. The method includes identifying a position of each of the light source, the first object, and the second object. The method includes identifying an irradiation direction of light radiated from the light source. The method includes identifying a first region and a second region of the virtual space illuminated by the light from the light source based on the position of the light source and the irradiation direction. The method includes determining whether the first object is visible in the virtual space based on the identified position of the first object and the location of each of the first and second regions. The method includes determining whether the second object is visible based on the identified position of the second object and the location of each of the first and second regions.

### TECHNICAL FIELD

This disclosure relates to a technology of providing a field-of-view image of a virtual space to a head-mounted device.

### BACKGROUND

When a virtual space is provided with use of a head-mounted device, a field-of-view image of the virtual space is generated in accordance with motion of a user wearing the head-mounted device. Therefore, a load of processing of generating the field-of-view image is large. Hardware for executing the processing of generating the field-of-view image is limited in processing capability, and is also restricted in processing time.

### PATENT DOCUMENTS

[Patent Document 1] JP 2006-4364 A

[Patent Document 2] JP 2002-92631 A

### SUMMARY

According to at least one embodiment of this disclosure, there is provided a method. The method includes defining a virtual space, the virtual space including a light source, a first object, and a second object. The method further includes identifying a position of the light source, a position of the first object, and a position of the second object in the virtual space. The method further includes identifying an irradiation direction of light radiated from the light source. The method further includes identifying a first region illuminated with the light in the virtual space based on the position of the light source and the irradiation direction. The method further includes identifying a second region, which is a region other than the first region in the virtual space. The method further includes identifying that the first object is arranged in the first region. The method further includes identifying that the second object is arranged in the second region. The method further includes processing the first object so as to be visible in the virtual space. The method further includes processing the second object so as to be invisible in the virtual space.

The above-mentioned and other objects, features, aspects, and advantages of the disclosure may be made clear from the following detailed description of this disclosure, which is to be understood in association with the attached drawings.

### BRIEF DESCRIPTION OF THE DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of an example of a yaw direction, a roll direction, and a pitch direction that are defined with respect to a right hand of the user according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field-of-view image of a user 5A in FIG. 12A according to at least one embodiment of this disclosure.

FIG. 13 A sequence diagram of processing to be executed by a system including an HMD interacting in a network according to at least one embodiment of this disclosure.

FIG. 14 A block diagram of a detailed configuration of modules of the computer according to at least one embodiment of this disclosure.

FIG. 15 A flowchart of processing to be executed by the HMD set according to at least one embodiment of this disclosure.

FIG. 16 A flowchart of processing to be executed according to at least one aspect of at least one embodiment of this disclosure.

FIG. 17 A flowchart of detailed processing to be executed according to at least one aspect of at least one embodiment of this disclosure.

FIG. 18A A diagram of an example of a mode of arrangement of objects and a virtual light source in the virtual space according to at least one embodiment of this disclosure.

FIG. 18B A diagram of an example of a field-of-view image corresponding to a field-of-view region in FIG. 18A according to at least one embodiment of this disclosure.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

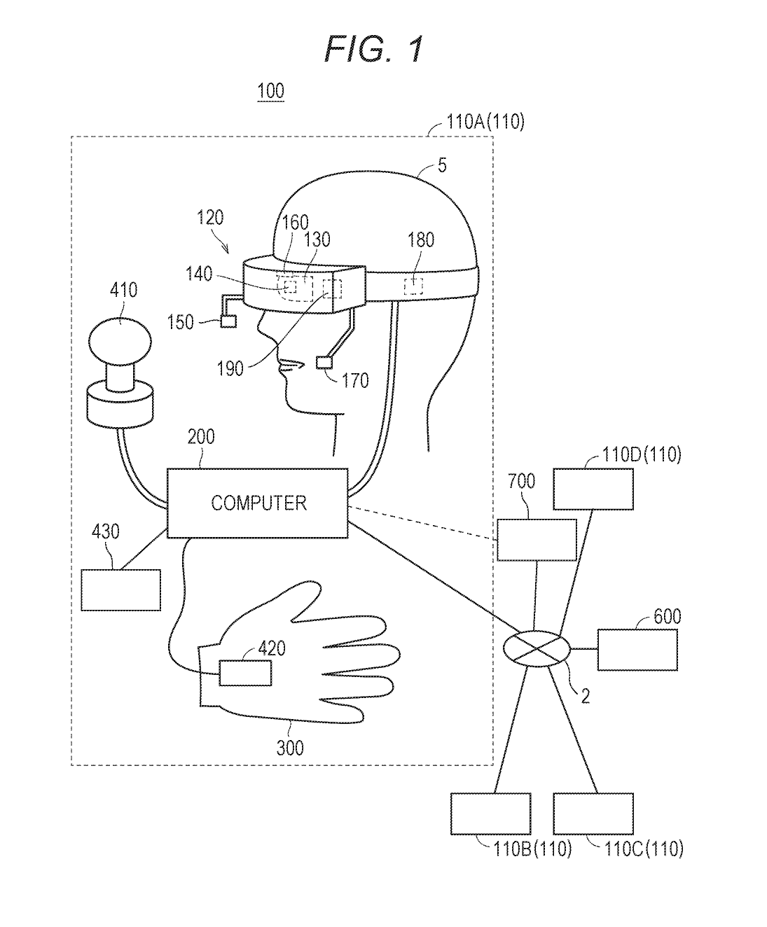

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least anyone of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

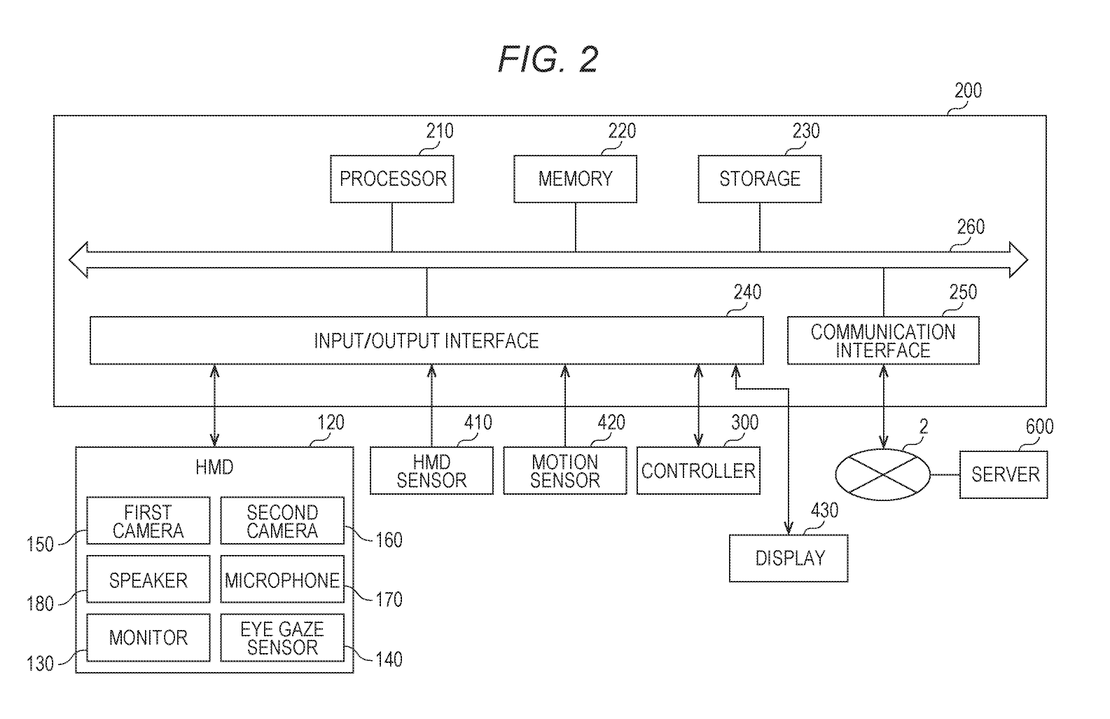

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes anyone of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth®, near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

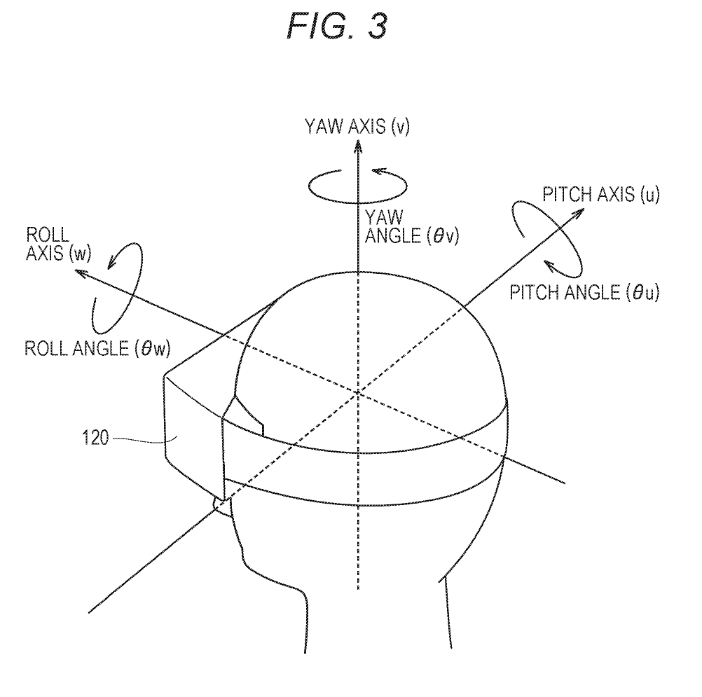

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

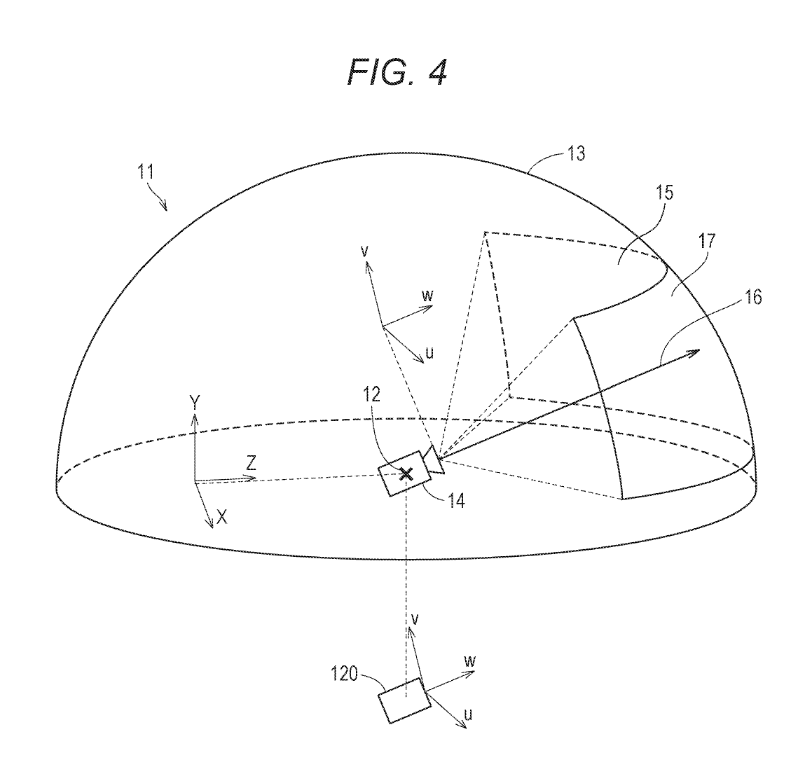

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

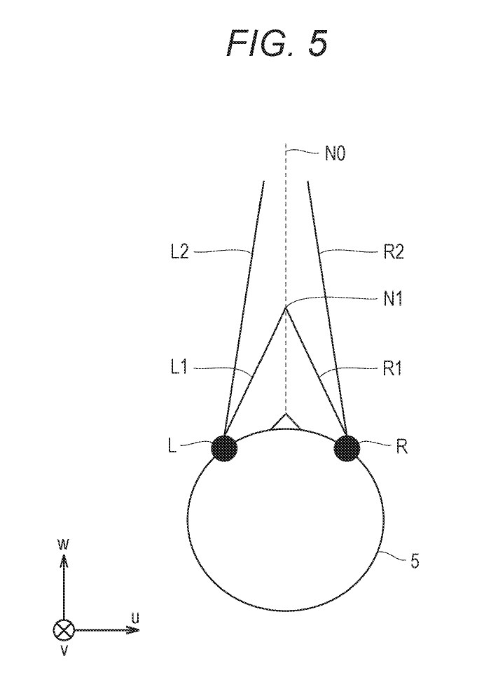

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight N0 of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight N0. The line of sight N0 is a direction in which the user 5 actually directs his or her lines of sight with both eyes. The line of sight N0 corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-View Region]

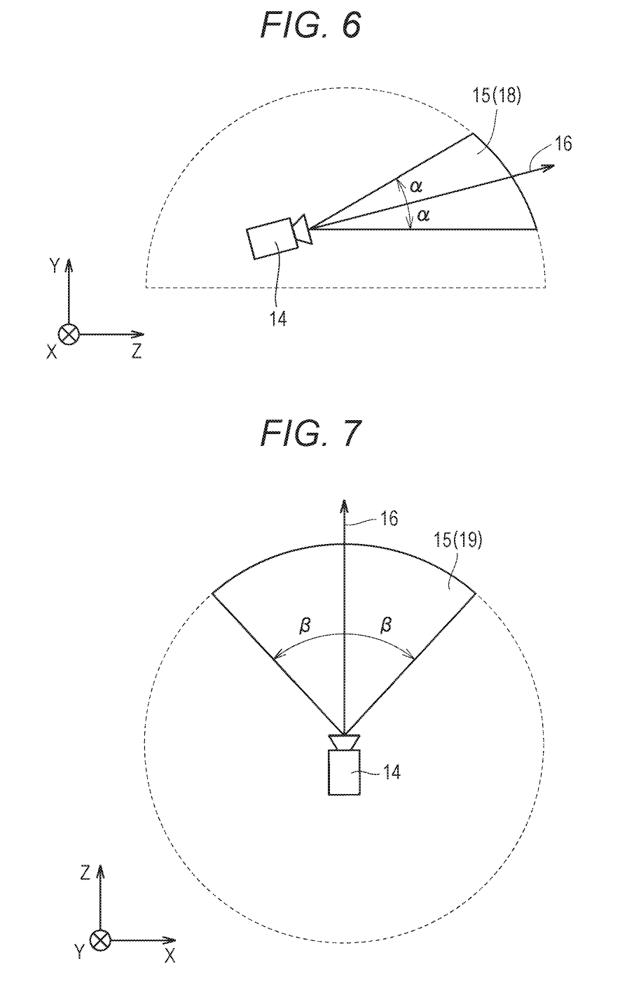

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

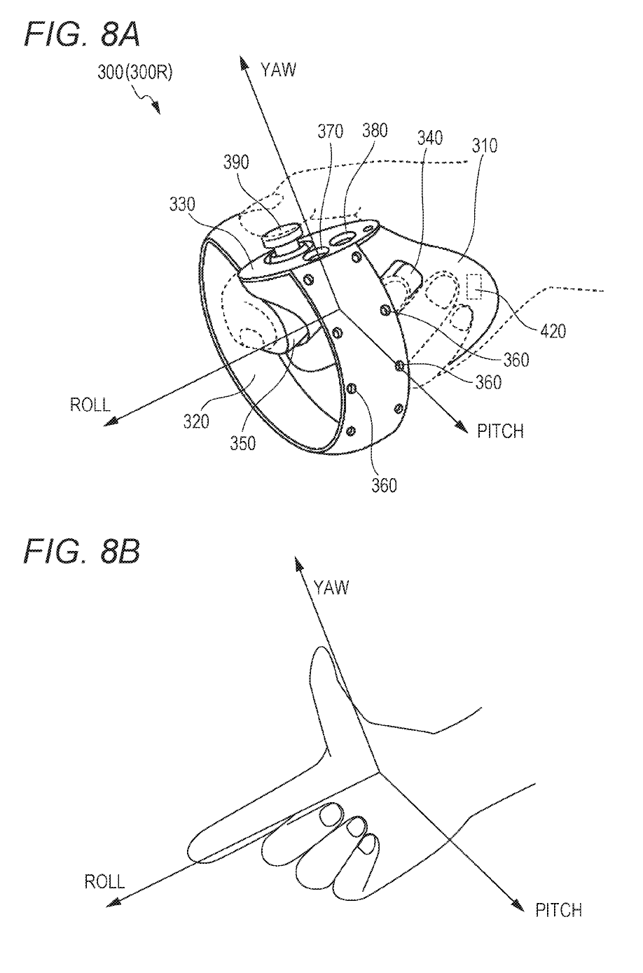

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIG. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane defined by the yaw-direction axis and the roll-direction axis when the user 5 extends his or her thumb and index finger is defined as the pitch direction.

[Hardware Configuration of Server]

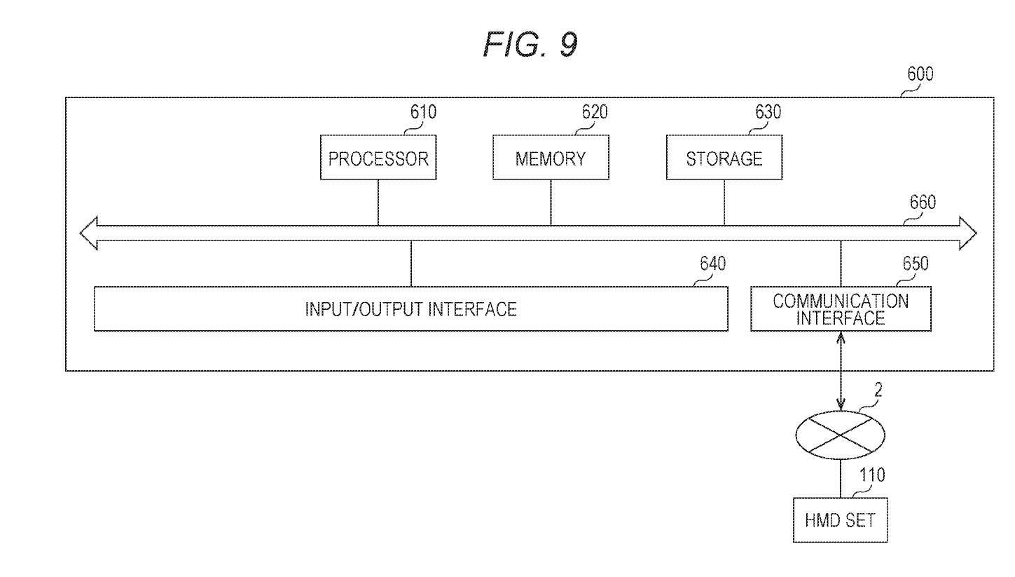

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

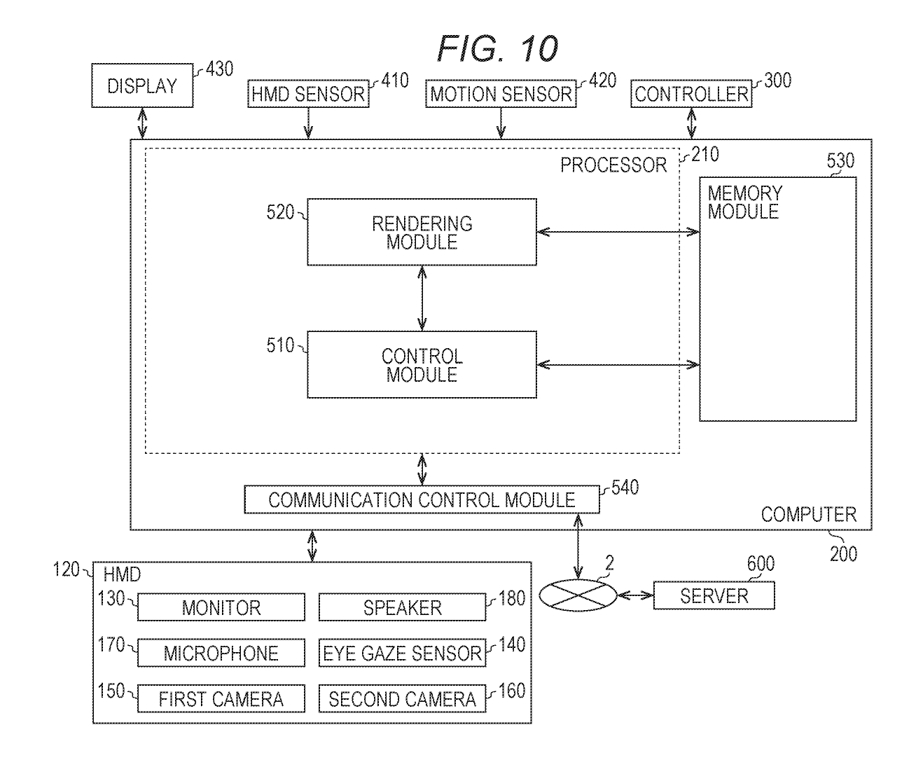

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity® provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

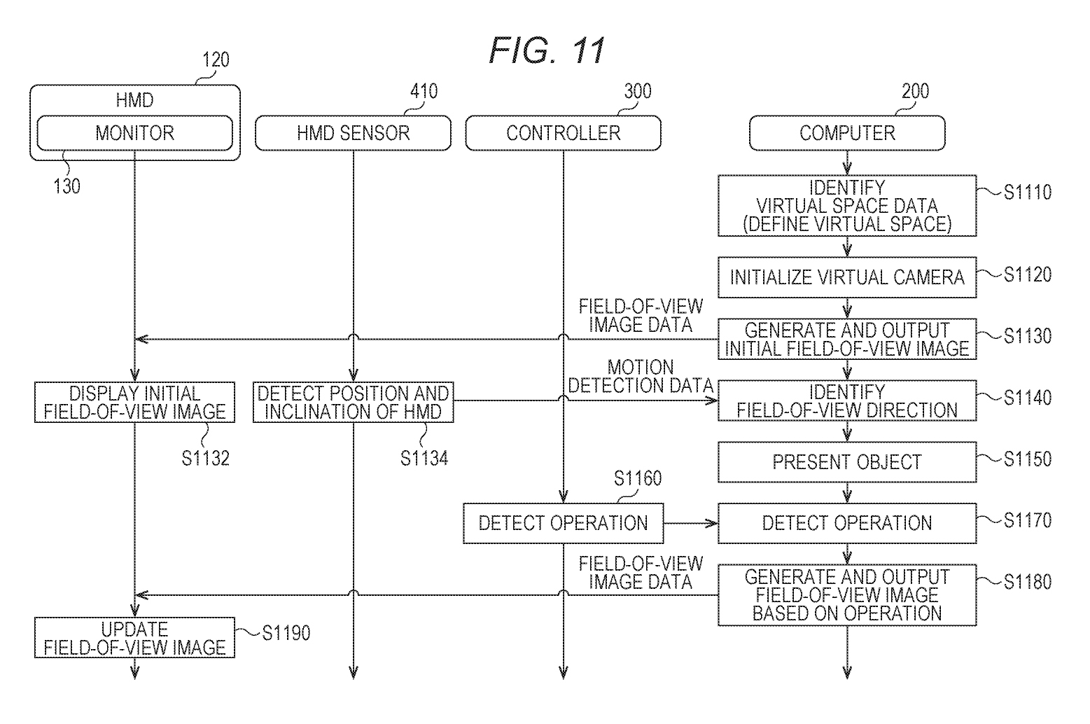

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

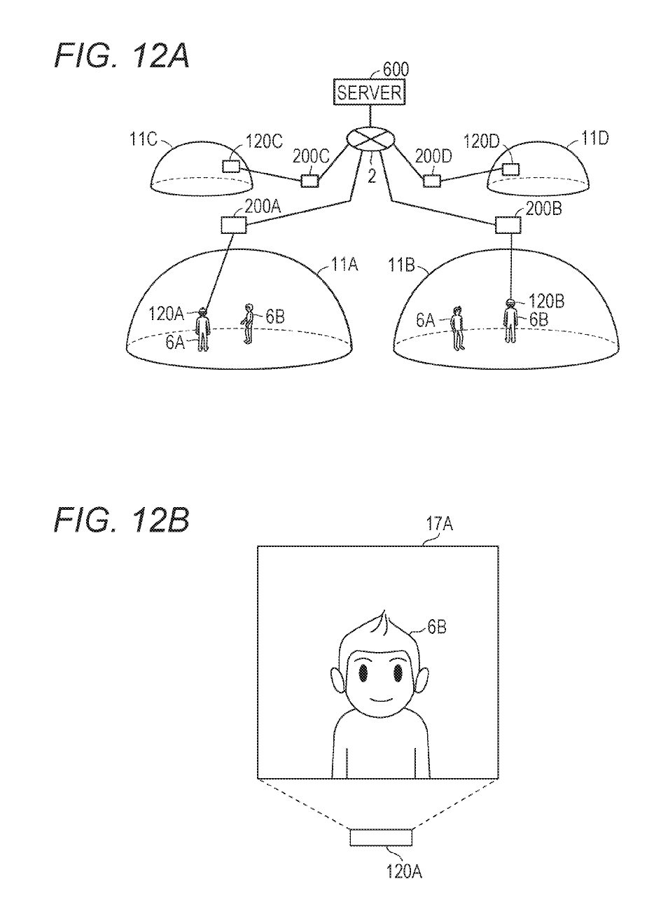

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

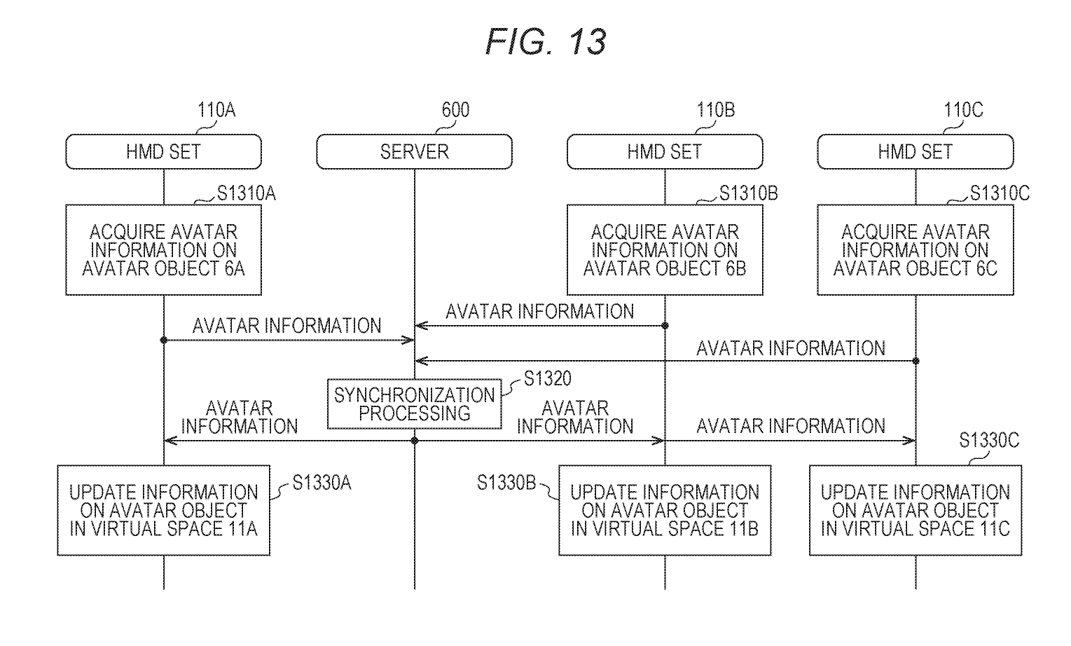

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Detailed Configuration of Modules]

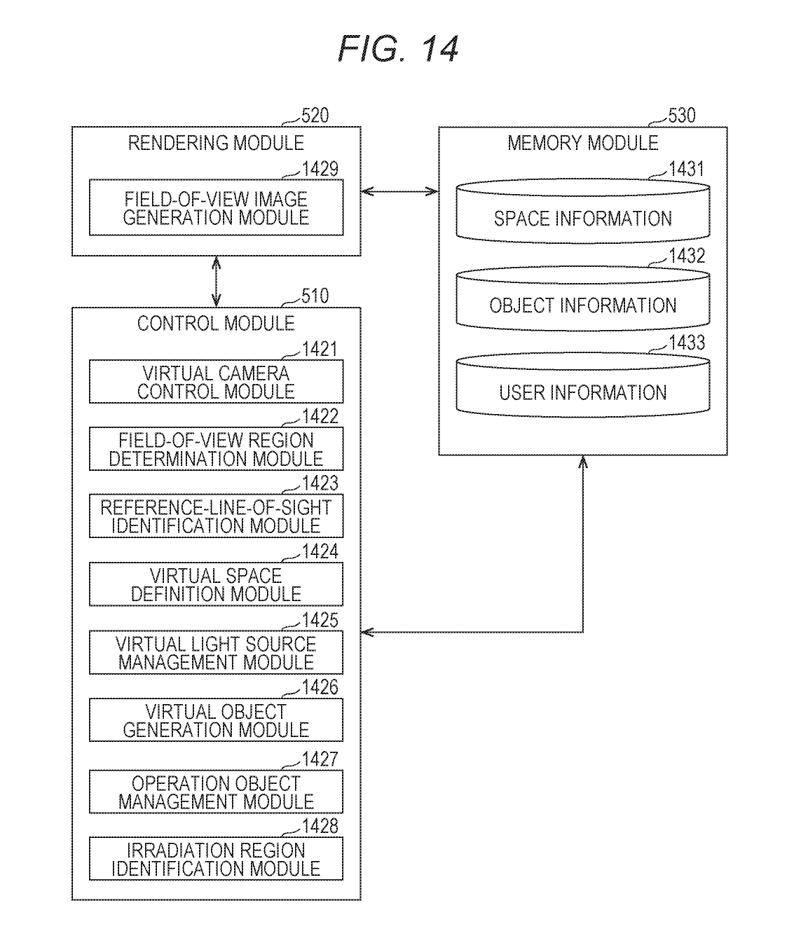

Now, with reference to FIG. 14, a description is given of a detailed configuration of modules of the computer 200. FIG. 14 is a block diagram of the detailed configuration of modules of the computer 200 according to at least one embodiment of this disclosure.

In FIG. 14, the control module 510 includes a virtual camera control module 1421, a field-of-view region determination module 1422, a reference-line-of-sight identification module 1423, a virtual space definition module 1424, a virtual light source management module 1425, a virtual object generation module 1426, a virtual object management module 1427, and an irradiation region identification module 1428. The rendering module 520 includes a field-of-view image generation module 1429. The memory module 530 stores space information 1431, object information 1432, and user information 1433.

In at least one aspect, the control module 510 controls display of an image on the monitor 130 of the HMD 120. The virtual camera control module 1421 arranges the virtual camera 14 in the virtual space 11, and controls, for example, the behavior and direction of the virtual camera 14. The field-of-view region determination module 1422 defines the field-of-view region 15 in accordance with the direction of the head of the user wearing the HMD 120. The field-of-view image generation module 1429 generates a field-of-view image to be displayed on the monitor 130 based on the determined field-of-view region 15.

The reference-line-of-sight identification module 1423 identifies the line of sight of the user 5 based on the signal from the eye gaze sensor 140.

The control module 510 controls the virtual space 11 to be provided to the user 5. The virtual space definition module 1424 generates virtual space data representing the virtual space 11, to thereby define the virtual space 11 in the HMD set 110.

The virtual light source management module 1425 manages the brightness of the virtual space 11. In at least one embodiment, the management of the brightness of the virtual space 11 includes, for example, moving the position of the virtual light source arranged in the virtual space 11, changing a light amount that is the intensity of light radiated from the virtual light source, changing an irradiation direction of the virtual light source, identifying the position of the virtual light source, and identifying the light amount of the virtual light source. In at least one aspect, the virtual light source stands still in the virtual space 11. In at least one aspect, the virtual light source is movable in the virtual space 11. A method of moving the virtual light source includes a method of moving the virtual light source by a computer program and a method of moving the virtual light source by the motion of the user 5. In the former method, for example, the sun arranged in the virtual space 11 may be considered as the virtual light source. In the latter method, for example, light of a candle held by the user in the virtual space 11 may be considered as the virtual light source. In at least one embodiment, the light amount of the virtual light source managed by the virtual light source management module 1425 is in a level that cannot illuminate the entire virtual space 11, for example.

The virtual object generation module 1426 generates an object to be provided in the virtual space 11. The object generated by the virtual object generation module 1426 includes various objects present in the real space. Those objects include, for example, a vase or a stone that is movable in accordance with the operation performed on the controller 300 by the user 5, or a tree or a house that is unmovable in accordance with the operation performed on the controller 300 by the user 5. The object generated by the virtual object generation module 1426 further includes a character indicating the user 5, a character to be controlled by the user 5, a player in a game program, and an opponent.

The virtual object management module 1427 manages the arrangement of the object provided in the virtual space 11. In at least one embodiment, the management of the arrangement of the object includes, for example, moving the position of the object in accordance with the operation performed on the controller 300 by the user 5, moving the position of the object based on an application program, and identifying the position at which the object is arranged.

The irradiation region identification module 1428 identifies the range in which the virtual light source irradiates the virtual space 11. For example, the irradiation region identification module 1428 identifies the range based on the position, the irradiation direction, and the light amount of the virtual light source.

The space information 1431 stores one or more templates defined to provide the virtual space 11.

The object information 1432 contains data for presenting an object in the virtual space 11. The data contains, for example, all the objects to be presented in the virtual space 2 defined by an application program.

The user information 1433 contains, for example, identification information on the user 5 of the HMD 120 and an authority associated with the user 5.

Further, the computer 200 includes a module (not shown) for outputting sound. The module for outputting sound is implemented by the processor 210. The module for outputting sound performs control of outputting sound from the speaker 180 of the HMD 120.

[Control Structure]

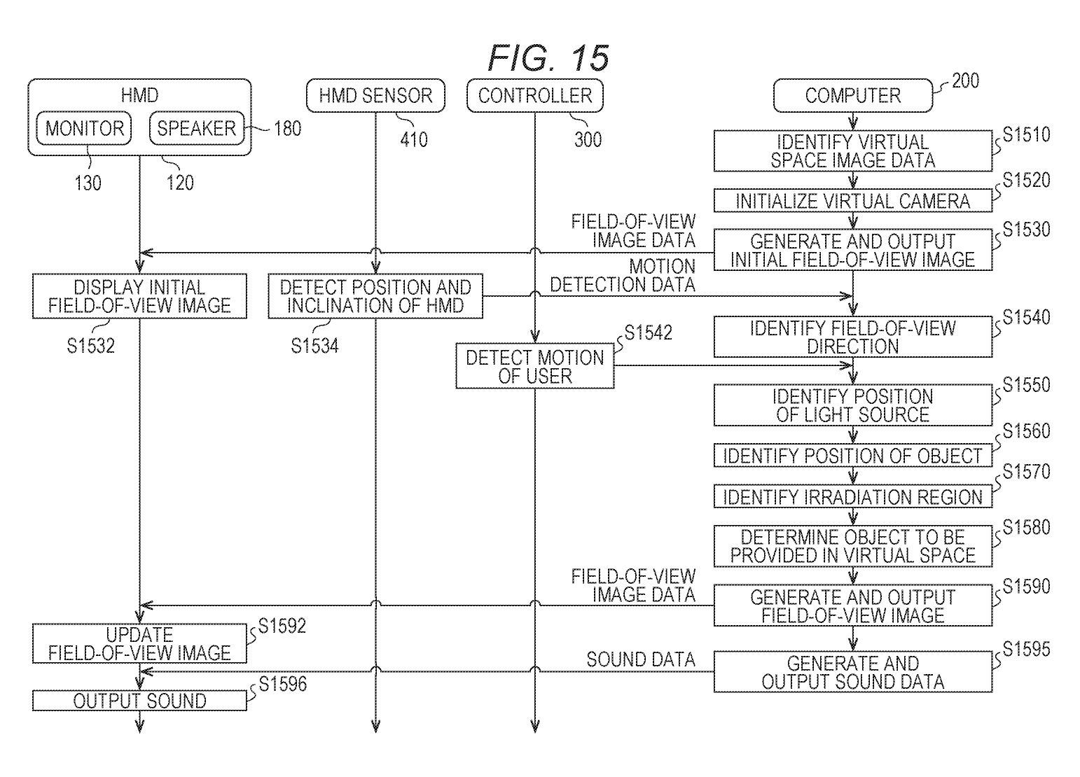

With reference to FIG. 15, the control structure of the HMD set 110 according to at least one embodiment of this disclosure is described. FIG. 15 is a flowchart of processing to be executed by the HMD set 100 according to at least one embodiment of this disclosure.

In Step S1510, the processor 210 serves as the virtual space definition module 1424 to identify virtual space image data and define the virtual space.

In Step S1520, the processor 210 initializes the virtual camera 14. For example, in a work area of the memory, the processor 210 arranges the virtual camera 14 at the center defined in advance in the virtual space 11, and matches the line of sight of the virtual camera 14 with the direction in which the user 5 faces.

In Step S1530, the processor 210 serves as the field-of-view image generation module 1429 to generate field-of-view image data for displaying an initial field-of-view image. The generated field-of-view image data is transmitted to the HMD 120 by a communication control module 540 via the field-of-view image generation module 1429.

In Step S1532, the monitor 130 of the HMD 120 displays the field-of-view image based on the field-of-view image data received from the computer 200. The user 5 wearing the HMD 120 may recognize the virtual space 11 through visual recognition of the field-of-view image.

In Step S1534, the HMD sensor 410 detects the position and the inclination of the HMD 120 based on a plurality of infrared rays emitted from the HMD 120. The detection results are transmitted to the computer 200 as motion detection data.

In Step S1540, the processor 210 identifies a field-of-view direction of the user 5 wearing the HMD 120 based on the position and inclination of the HMD 120. The processor 210 executes an application program, and arranges an object in the virtual space 11 based on a command contained in the application program.

In Step S1542, the controller 300 detects motion of the user 5 based on a signal output from the motion sensor 420. In at least one aspect, the motion of the user 5 is detected based on an image from a camera arranged around the user 5.

In Step S1550, the processor 210 identifies the position of the virtual light source in the virtual space 11. The position of the virtual light source is managed by the virtual light source management module 1425. For example, the processor 210 determines a position in the uvw-coordinate system at which the virtual light source is arranged based on information on the position on the virtual light source managed by the virtual light source management module 1425.

In Step S1560, the processor 210 identifies the position of the object in the virtual space 11. The position of the object is managed by the virtual object management module 1427. For example, the processor 210 identifies which position on the uvw coordinate system the virtual light source is arranged at based on the information related to the position of the object managed by the virtual object management module 1427.

In Step S1570, the processor 210 identifies an irradiation region based on the position and the irradiation direction of the virtual light source. The irradiation region is a region to be illuminated with light from the virtual light source. In at least one aspect, the irradiation region is a region in which an object present in the region can be visually recognized by human eyes. The processor 210 identifies the irradiation region based on, for example, the intensity of light radiated from the virtual light source and the distance from the virtual light source. In at least one aspect, the irradiation region refers to a region in which the amount of light radiated from a light source is equal to or larger than a reference value. In at least one embodiment, the reference value is a predetermined value, for example, an amount of light that provides brightness in a level that is recognizable by the eyes of the user 5. In at least one aspect, the reference value varies along with an elapse of time. Specifically, the processor 210 may be configured to gradually decrease the reference value along with the elapse of time. When the reference value is decreased along with the elapse of time, a phenomenon in which the human eyes get used to the darkness and objects become visible is artificially created. The amount of light to be radiated to each region of the virtual space 11 may be obtained based on the direction of illumination by the virtual light source, the intensity of light radiated from the virtual light source, and the distance from the virtual light source.

In Step S1580, the processor 210 determines the object to be provided in the virtual space 11 based on the position of the object and the irradiation region. The processor 210 determines to provide the object positioned in the irradiation region among the objects positioned in the virtual space 11. In other words, the processor 210 does not provide the object positioned outside of the irradiation region among the objects positioned in the virtual space 11. As a result, the processor 210 does not display the object positioned outside of the irradiation region as the field-of-view image. In at least one aspect, the processor 210 determines the object based on the color of the object in addition to the relationship between the irradiation region and the position of the object. For example, the processor 210 is more likely to provide the object in the virtual space as the object has a color with higher light reflectance, and is less likely to provide the object in the virtual space as the object has a color with higher light absorptance. In at least one aspect, the processor 210 determines the object to be provided based on the position of the user 5 in addition to the relationship between the irradiation region and the position of the object. For example, in at least one embodiment, when two objects are present in the virtual space 11, the processor 210 is provides the object closer to the user 5 in the virtual space 11 and does not provide the object which is farther from the user 5 in the virtual space 11.

In Step S1590, the processor 210 generates field-of-view image data, and outputs the generated field-of-view image data. The processor 210 serves as the field-of-view image generation module 1429 to generate field-of-view image data for displaying a field-of-view image based on the determination of Step S1580 and the field-of-view direction. The processor 210 transmits the generated field-of-view image data to the HMD 120 via the field-of-view image generation module 1429 using the communication control module.

In Step S1592, the monitor 130 of the HMD 120 updates the field-of-view image based on the field-of-view image data, which is received from the computer 200, and displays the updated field-of-view image.

In Step S1595, when the processor 210 outputs sound along with update of the field-of-view image, the processor 210 generates sound data and outputs the generated sound data to the HMD 120. For example, when one object is moved from the irradiation region to a region outside of the irradiation region, the object is not provided in the field-of-view image obtained after the object is moved. However, when the object outputs a sound, the sound of the object is output. In this manner, for example, in a case where an animal moves while making a sound from the irradiation region to a region outside of the irradiation region or a case where a vase falls to move from the irradiation region to a region outside of the irradiation region, a sound can be output although the object is not visually recognized by the user.

In Step S1596, the HMD 120 outputs sound from the speaker 180 based on sound data received from the computer 200.

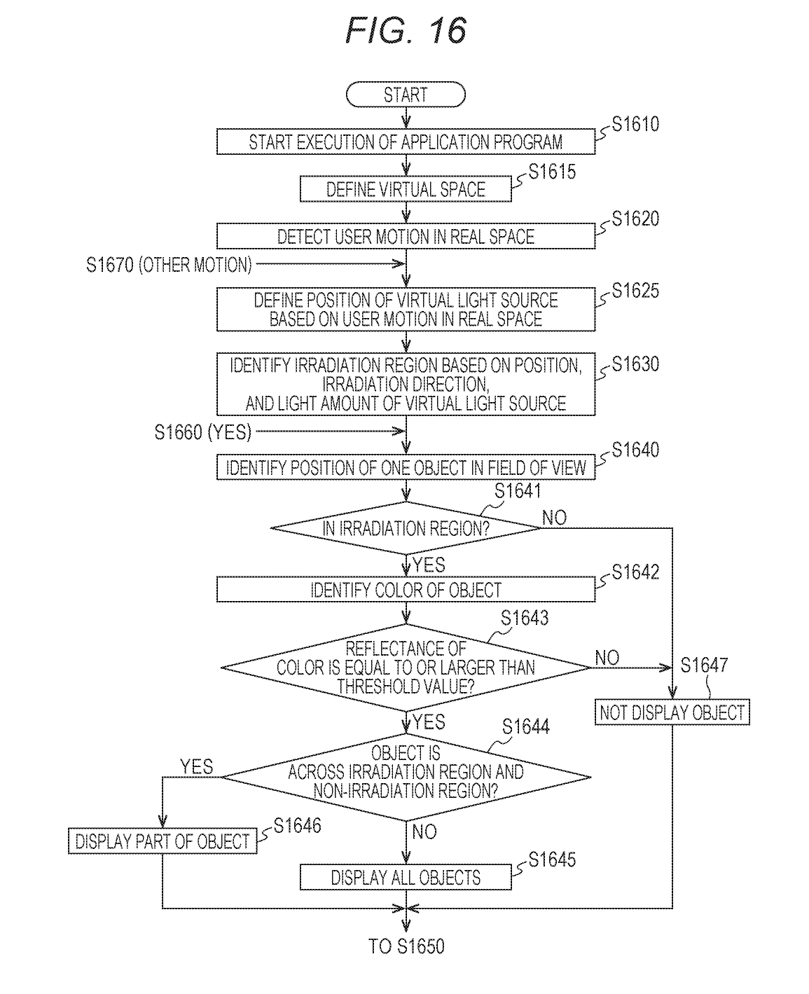

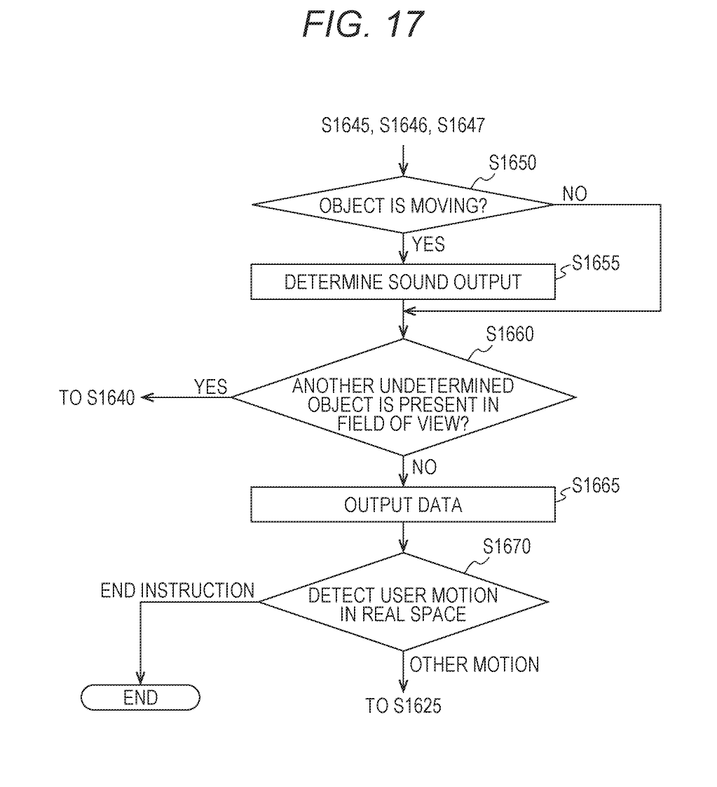

With reference to FIG. 16 and FIG. 17, a further description is given of a control structure of the computer 200. FIG. 16 and FIG. 17 are flowcharts of processing to be executed by the processor 210 of the computer 200 according to at least one aspect of at least one embodiment of this disclosure.

In Step S1610, the processor 210 starts execution of an application program based on an instruction from the user 5. The application program is a program capable of displaying in the virtual space an event that occurs in the real space. The application program contains, for example, a sports game program, a racing game program, or other game programs in which an opponent may be present. However, the application program may be an application program other than the game program.

In Step S1615, the processor 210 defines the virtual space, and outputs to the HMD 120 information for displaying the initial field-of-view image on the monitor 130. In at least one embodiment, the information contains the field-of-view image data and the sound data.

In Step S1620, the processor 210 detects motion of the user 5 in the real space based on the signal from the controller 300. The motion of the user 5 includes, for example, motion of moving the field-of-view region 15 by turning the neck of the user 5 vertically and laterally, motion of moving the object by operating the controller 300 by the user 5, or motion of moving the virtual light source.

In Step S1625, the processor 210 identifies the position of the virtual light source based on the detected motion of the user 5 in the real space. At this time, the processor 210 identifies the field-of-view region of the user 5 based on the motion of the user 5. The position of the virtual light source may be determined in advance by an application program, or may be moved based on the motion of the user 5. In at least one embodiment, the position of the light source is movable based on the motion of the user 5. A situation in which the position of the light source is movable based on the motion of the user 5 includes, for example, a situation in which the user 5 moves in the darkness relying on light of a flashlight.

In Step S1630, the processor 210 identifies the irradiation region based on the position, the irradiation direction, and the light amount of the virtual light source.

In Step S1640, the processor 210 identifies the position of one object in the field of view. Specifically, in Step S1640, the processor 210 identifies the position of one object among the objects positioned in the identified field-of-view region.

In Step S1641, the processor 210 determines whether or not the one object whose position is identified in Step S1640 is positioned in the irradiation region identified in Step S1630. When the object is not positioned in the irradiation region (N0 in Step S1641), in Step S1647, the processor 210 determines not to render the object.

When the object is positioned in the irradiation region (YES in Step S1641), in Step S1642, the processor 210 identifies the color of the object based on the information on the object, which is managed by the virtual object management module 1427. After the color of the object is identified, in Step S1643, the processor 210 determines whether or not the reflectance of the color identified in Step S1642 is equal to or larger than a threshold value. The reflectance of the color is determined in advance for each color. The threshold value is a predetermined value. In at least one embodiment, the threshold value is a predetermined value, and may be, for example, a reflectance in a level in which the user 5 is able to recognize the light reflected by the object. The processor 210 may set the threshold value every time Step S1643 is executed based on the intensity of light illuminating the object and the distance from the object to the virtual camera 14.

The processing of Step S1642 and Step S1643 may not be executed. In other words, the processor 210 determines whether or not to render the object based on whether or not the object is positioned in the irradiation region regardless of the color of the object.

When the reflectance of the color of the object is smaller than the threshold value (N0 in Step S1643), in Step S1647, the processor 210 determines not to display the object. When the reflectance of the color of the object is equal to or larger than the threshold value (YES in Step S1643), the processor 210 advances the processing to Step S1644. In Step S1644, the processor 210 determines whether the object is arranged across the irradiation region and a non-irradiation region other than the irradiation region based on the position of the object and the irradiation region. When the object is not arranged across the irradiation region and the non-irradiation region (N0 in Step S1644), that is, when the entire object is arranged in the irradiation region, in Step S1645, the processor 210 determines to display the entire object.

When the object is arranged across the irradiation region and the non-irradiation region (YES in Step S1644), the processor 210 advances the processing to Step S1646. In Step S1646, the processor 210 determines to prevent a part of the object positioned in the non-irradiation region from being displayed, and to display a part thereof positioned in the irradiation region. In at least one embodiment, when a part of the object is prevented from being displayed, the processor 210 may perform processing of blurring a boundary between the display portion and the non-display portion. The blurring processing includes, for example, increasing the transparency of the boundary portion between the display portion and the non-display portion, and using the blurring effect.

In Step S1650 of FIG. 17, the processor 210 determines whether or not the object is moving. Whether or not the object is moving is determined based on whether or not there is a difference between the previously identified position of the object and the currently identified position of the object. In response to a determination that the object is moving (YES in Step S1650), in Step S1655, the processor 210 determines to output a sound. In this manner, for example, when a vase, which is an object, is moved to be broken, a vase braking sound is output based on the movement of the vase.

In Step S1660, the processor 210 determines whether or not another object that is undetermined in Step S1640 is present in the field of view. The processor 210 repeats the processing of Step S1640 to Step S1660 until the determination processing of Step S1640 is performed for all of the objects positioned in the field of view.

When the processor 210 ends determining all of the objects in the field of view, in Step S1665, the processor 210 outputs data to the HMD 120. The data output to the HMD 120 includes information on the object to be rendered and information on sound to be output along with the movement of the object. When the HMD 120 receives the data transmitted from the processor 210, the HMD 120 displays the object on the monitor 130 and outputs a sound from the speaker 180 based on the data.

In this manner, among the objects positioned in the field of view, the object positioned in the darkness to which the light of the virtual light source does not reach is not rendered. According to at least one embodiment, as for the object positioned in the field of view but is only partially visible because a part thereof is present in the darkness, the part of the object positioned in the darkness is not rendered. The object positioned in the darkness to which the light of the virtual light source does not reach is invisible to the user 5 even when the object is displayed on the monitor 130, and hence the visual effect is not affected even when the object is not rendered. Therefore, according to at least one embodiment, the load of the processing for generating the field-of-view image is reduced without affecting the visual effect. When the object is moved and thus the object is moved from the irradiation region to the darkness in the field of view, output of a sound effect corresponding to the object is continued (Step S1650, Step S1655). For example, when a crow moves while cawing from the irradiation region to the darkness, the rendering of the crow is omitted based on the movement to the darkness, but the cawing of the crow continues. Therefore, even when the rendering of the object having a sound effect is omitted along with the movement of the object to the darkness, the user does not feel a sense of strangeness.

In Step S1670, the processor 210 detects an operation by the user 5 in the real space. When the operation is an operation of instructing end of the application program, the processor 210 ends the processing. When the operation is an operation of giving another instruction, the processor 210 switches control to Step S1625.

The other instructions include, for example, an instruction to move the object, an instruction to move the light source, and an instruction to move the field of view. For example, when the instruction to move the light source is output, the positional relationship between the object and the light source changes, and the object that has been positioned in the irradiation region may be positioned in the non-irradiation region. In this case, in Step S1647, the processor 210 determines not to display the object. That is, the processor 210 determines to prevent the object from being displayed.

When the object that has been positioned in the irradiation region is positioned in the non-irradiation region based on the change in positional relationship between the object and the light source because of the output of the instruction to move the object, in Step S1647, the processor 210 determines not to display the object. Even when the processor 210 determines not to display the object, the HMD 120 outputs a sound based on the movement of the object, and hence the sound is continuously output even when the object is prevented from being displayed.

In at least one aspect, the HMD 120 has an information processing function and a communication function. For example, when the HMD 120 includes a processor, a memory, and a communication apparatus, processing by the processor 210 may be executed by, for example, the processor of the HMD 120. In this case, the HMD 120 is able to directly communicate to/from the server 600 without intervention of the computer 200. As an example, when a smartphone is attachable to the HMD 120, the processor of the smartphone is able to use its communication function to communicate to/from the server 600.

According to at least one embodiment, among the objects appearing in the application program, an object that is positioned in the darkness to which light of the virtual light source is not radiated and that is invisible by the user 5 even when the object is displayed on the monitor 130 is not rendered. Therefore, the number of objects to be rendered on the monitor 130 can be reduced. As a result, the load for generating the field-of-view image can be reduced.

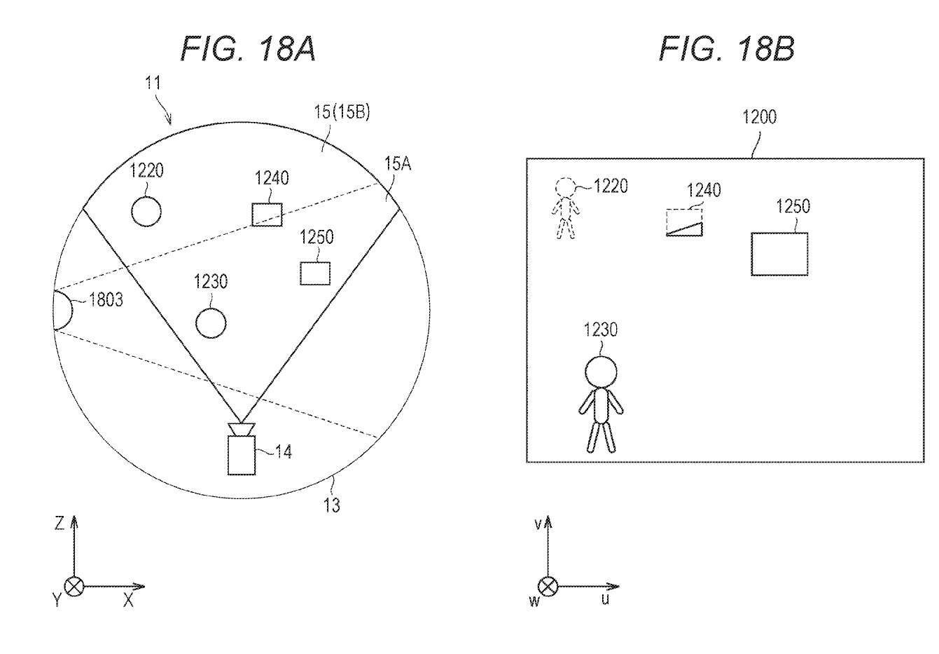

With reference to FIG. 18A and FIG. 18B, arrangement of objects according to at least one embodiment of this disclosure is described. FIG. 18A and FIG. 18B are diagrams of an example of a mode of arrangement of the objects and the virtual light source in the virtual space 11 according to at least one embodiment of this disclosure.

FIG. 18A is a diagram of the arrangement of, in the panorama image 13 (virtual space image), objects 1220, 1230, 1240, and 1250, a virtual light source 1803, and the virtual camera 14 according to at least one embodiment of this disclosure. A region surrounded by the two solid lines extending from the virtual camera 14 is the field-of-view region 15. A region surrounded by the two dotted lines extending from the virtual light source 1803 is an irradiation region 15A.

The objects 1220 and 1230 are objects that move in the virtual space 11, and are, for example, characters resembling other users positioned in the field-of-view region 15. The object that moves in the virtual space 11 may be, for example, a vase or a building block whose position is changed by the operation of the user 5, or may be an opponent in a game program. Meanwhile, the objects 1240 and 1250 are objects such as a building and a tree whose position does not change in the virtual space 11.

FIG. 18B is a diagram of an example of a field-of-view image 1200 that may be recognized by the user 5 wearing the HMD 120 according to at least one embodiment of this disclosure. The field-of-view image 1200 in FIG. 18B is a field-of-view image of the field-of-view region 15 as viewed from the position of the virtual camera 14 illustrated in FIG. 18A. The object indicated by the dotted line in FIG. 18B is an object that is positioned in the field-of-view region 15 but is not displayed as the field-of-view image 1200 because the object is positioned in a non-irradiation region 15B. For example, the object 1220 indicated by the dotted line is not displayed on the monitor 130. The object 1240 is positioned in the field-of-view region 15 but is positioned across the irradiation region 15A and the non-irradiation region 15B. Therefore, a part of the object 1240 positioned in the irradiation region 15A is displayed on the monitor 130, but the part positioned in the non-irradiation region 15B is not displayed on the monitor 130.

As described above, the processor 210 does not display the object positioned in the non-irradiation region 15B, and hence the load of the processing for generating the field-of-view image 1217 can be reduced.

### Scene to which at Least One Embodiment is Applicable

At least one embodiment is effectively applicable to the following attraction to be provided by the virtual space. Light weakly illuminates only a limited region in a dark virtual space as a whole. The foot side of the user is invisible due to the darkness. When the user makes a sound, a zombie attacks the user. The hand of the user who is walking carefully erroneously touches a vase placed at the end of a table. The user looks at the vase falling from the table to the darkness on the foot side. Then, a vase breaking sound echoes in the darkness. In such a scene, at a stage at which the vase moves from the irradiation region to the non-irradiation region on the foot side of the user, the rendering of the vase is omitted, but the vase breaking sound is output at a timing at which the vase falls on the floor. The falling time from when the vase starts to fall to when the vase hits the floor may be stored in the processor 210 or the memory 220 in advance so that the vase breaking sound is output after the falling time elapses. That is, in Step S1595 of FIG. 15, the processor 210 outputs a sound corresponding to the object after the object is prevented from being displayed based on the movement of the position of the object from the irradiation region to the non-irradiation region.

<Conclusion>

Technical features of at least one embodiment disclosed above are summarized in the following manner, for example.

(Configuration 1) According to at least one embodiment of this disclosure, there is provided a method to be executed on a computer to provide an object in a virtual space. The method includes defining (Step S1615) a virtual space. The method further includes identifying (Step S1625) a position of a virtual light source and a position of one or more objects in the virtual space. The method further includes identifying (Step S1630) an irradiation region 15A illuminated with light from the virtual light source based on the position of the virtual light source and an irradiation direction. The method further includes providing (Step S1645), in the virtual space, objects 1230, 1250, and 1240 positioned in the irradiation region 15A among the one or more objects 1220 to 1250 in the virtual space.

(Configuration 2) According to at least one embodiment of this disclosure, the identifying (Step S1630) of the irradiation region 15A includes identifying the irradiation region 15A based on whether or not an amount of light radiated from the virtual light source is in a region of a threshold value (reference value) or more.

(Configuration 3) According to at least one embodiment of this disclosure, the providing (Step S1645) of the objects in the virtual space includes preventing a part positioned in a non-irradiation region 15B of the object 1240 positioned across the irradiation region 15A and the non-irradiation region 15B from being provided.

(Configuration 4) According to at least one embodiment of this disclosure, the method further includes preventing (Step S1647), among the objects that are positioned in the irradiation region 15A and displayed on the monitor 130, an object that is moved to be positioned in the non-irradiation region 15B from being displayed.

(Configuration 5) According to at least one embodiment of this disclosure, preventing (Step S1647) of the object from being displayed includes preventing the object that is moved from the irradiation region 15A to be positioned in the non-irradiation region 15B from being displayed based on a change in positional relationship between the virtual light source and the object.

(Configuration 6) According to at least one embodiment of this disclosure, the preventing (Step S1647) of the object from being displayed includes preventing the object that is moved to be positioned in the non-irradiation region 15B from being displayed when the position of the virtual light source 1203 is moved based on motion of a user 5 or the like and thus the irradiation region 15A is changed.

(Configuration 7) According to at least one embodiment of this disclosure, the preventing (Step S1647) of the object from being displayed includes preventing the object from being displayed when the position of the object is changed from the irradiation region 15A to the non-irradiation region 15B based on the motion of the user 5 or the like.

(Configuration 8) According to at least one embodiment of this disclosure, the method further includes outputting (Step S1596) a sound from a speaker 180 based on the movement of the object. The outputting (Step S1596) of the sound from the speaker 180 includes continuing the output of the sound even when the object is prevented from being displayed based on the movement of the position of the object from the irradiation region 15A to the non-irradiation region 15B.

(Configuration 9) According to at least one embodiment of this disclosure, the method further includes providing (Step S1643) the object in the virtual space 11 based on the position of the irradiation region and a color of the object.

As described above, according to at least one embodiment of this disclosure, with the method, only the object positioned in the irradiation region 15A is displayed on the monitor 130 of the HMD 120. Therefore, an object that cannot be recognized by the user 5 even when the object is displayed on the monitor 130 of the HMD 120 because of the darkness is not displayed. As a result, the load of the processing for generating the field-of-view image can be reduced.

It is to be understood that the embodiments disclosed herein are merely examples in all aspects and in no way intended to limit this disclosure. The scope of this disclosure is defined by the appended claims and not by the above description, and one of ordinary skill would understand that this disclosure encompasses all modifications made within the scope and spirit equivalent to those of the appended claims.

In the at least one embodiment described above, the description is given by exemplifying the virtual space (VR space) in which the user is immersed using an HMD. However, a see-through HMD may be adopted as the HMD. In this case, the user may be provided with a virtual experience in an augmented reality (AR) space or a mixed reality (MR) space through output of a field-of-view image that is a combination of the real space visually recognized by the user via the see-through HMD and a part of an image forming the virtual space. In this case, action may be exerted on a target object in the virtual space based on motion of a hand of the user instead of the operation object. Specifically, the processor may identify coordinate information on the position of the hand of the user in the real space, and define the position of the target object in the virtual space in connection with the coordinate information in the real space. With this, the processor can grasp the positional relationship between the hand of the user in the real space and the target object in the virtual space, and execute processing corresponding to, for example, the above-mentioned collision control between the hand of the user and the target object. As a result, an action is exerted on the target object based on motion of the hand of the user.

1-8. (canceled)

9. A method, comprising:
defining a virtual space, wherein the virtual space comprises a light source, and a first object;
identifying a position of the light source, and a position of the first object in the virtual space;
identifying an irradiation direction of light radiated from the light source;
identifying a first region of the virtual space illuminated by the light from the light source based on the position of the light source and the irradiation direction;
identifying a second region of the virtual space, which is a region other than the first region in the virtual space;
determining whether the first object is visible in the virtual space based on the identified position of the first object and the location of each of the first region and the second region.

10. The method according to claim 9, further comprising:
identifying an intensity of the light;
identifying a third region in the virtual space in which the intensity of the light is equal to or larger than a threshold value as the first region; and
identifying a fourth region in the virtual space in which the intensity of the light is smaller than the threshold value as the second region.

11. The method according to claim 10, wherein the determining whether the first object is visible comprises determining that the first object is visible in response to a determination that the first object is located in the third region.

12. The method according to claim 10, wherein the determining whether the first object is visible comprises determining that the first object is invisible in response to a determination that the first object is located in the fourth region.

13. The method according to claim 9, wherein the determining whether the first object is visible comprises:
determining that a first part of the first object located in the first region is visible; and
determining that a second part of the first object located in the second region is invisible.

14. The method according to claim 9, further comprising:
moving the position of the first object from the first region to the second region; and
changing the first object from being visible in the first region to being invisible in the second region.

15. The method according to claim 14, further comprising:
outputting a sound associated with the first object based on movement of the first object while the first object is arranged in the first region;
continuing output of the sound associated with the first object after the first object is invisible.

16. The method according to claim 15, further comprising:
continuing the output of the sound based on continued movement of the first object after the first object is invisible; and
ending the output of the sound based on an end of the movement of the first object in response to ending of the movement of the first object.

17. The method according to claim 14,
wherein the virtual space further comprises a second object, and
wherein the method further comprises:
identifying a position of the second object in the virtual space;
determining whether the second object is visible in the virtual space based on the identified position of the second object and the location of each of the first region and the second region; and
preventing a sound associated with the second object from being output based on movement of the second object in response to a determination that the second object is in the second region.

18. The method according to claim 9, further comprising:
moving the light source;
updating the first region and the second region based on the movement of the light source.

19. The method according to claim 18, further comprising:
changing the first object from visible to invisible in response to the movement of the light source changing the location of the first object from the first region to the updated second region.

20. The method according to claim 9, further comprising:
identifying a color of the first object,
wherein the determining whether the first object is visible comprises determining whether the first object is visible based on the color of the first object.

21. The method according to claim 20, wherein the determining whether the first object is visible comprises determining that the first object is visible in response to the first object being located in the first region and the color of the first object satisfying a given condition.

22. The method according to claim 20, wherein the determining whether the first object is visible comprises determining that the first object is invisible in response to the first object being located in the first region and the color of the first object failing to satisfy a given condition.

23. The method according to claim 9, further comprising:
identifying a reflectance of the first object,
wherein the determining whether the first object is visible comprises determining whether the first object is visible based on the reflectance of the first object.

24. The method according to claim 23, wherein the determining whether the first object is visible comprises determining that the first object is visible in response to the first object being located in the first region and the reflectance of the first object satisfying a given condition.

25. The method according to claim 23, wherein the determining whether the first object is visible comprises determining that the first object is invisible in response to the first object being located in the first region and the reflectance of the first object failing to satisfy a given condition.

26. The method according to claim 9, further comprising:
determining that a first part of the first object located in the first region is visible;
determining that a second part of the first objected located in the second region is invisible; and
blurring a third part of the first object located between the first part of the first object and the second part of the first object.

27. The method according to claim 26, wherein the blurring of the third part of the first object comprises increasing transparency of the third part.

28. The method according to claim 9, further comprising:
displaying the first region using a head-mounted display (HMD).
